(19) United States
(12) Patent Application Publication
(10) Pub. No.: US 2017/0092186 A1
(43) Pub. Date: Mar. 30, 2017

(54) DISPLAY PANEL DRIVING APPARATUS PERFORMING SPATIAL GAMMA MIXING, METHOD OF DRIVING DISPLAY PANEL USING THE SAME AND DISPLAY APPARATUS HAVING THE SAME

(71) Applicant: SAMSUNG DISPLAY CO., LTD., YONGIN-SI (KR)

(72) Inventors: WOO-JUNG JUNG, CHEONAN-SI (KR); BYUNG-KIL JEON, HWASEONG-SI (KR); DONG-HYUN YEO, YONGIN-SI (KR); SUHYUN JEONG, GWANGJU-SI (KR); YONG BUM KIM, SUWON-SI (KR)

(21) Appl. No.: 15/094,195

(22) Filed: Apr. 8, 2016

(30) Foreign Application Priority Data
Sep. 30, 2015 (KR) 10-2015-0137413

(51) Int. Cl. G09G 3/20

(52) U.S. Cl. CPC G09G 3/2092; G09G 2310/0264; G09G 2320/0673

(57) ABSTRACT

A display panel driving apparatus includes a data processor, a data driving circuit and a gate driving circuit. The data processor is configured to analyze image data, calculate an application rate value of a spatial gamma mixing which displays high gamma data and low gamma data on a display panel, perform the spatial gamma mixing on the image data according to the application rate value, and output image processed image data. The data driving circuit is configured to generate a data signal based on the image processed image data output from the data processing circuit, and output the data signal to a data line of the display panel. The gate driving circuit is configured to output a gate signal to a gate line of the display panel. Thus, display quality of a display apparatus may be increased.

### CROSS-REFERENCE TO RELATED APPLICATION

This application claims priority under 35 U.S.C. §119 to Korean Patent Application No. 10-2015-0137413, filed on Sep. 30, 2015 in the Korean Intellectual Property Office (KIPO), the contents of which are herein incorporated by reference in their entireties.

### TECHNICAL FIELD

Exemplary embodiments of the present inventive concept relate to a display panel driving apparatus, and more particularly, exemplary embodiments of the present inventive concept relate to a display panel driving apparatus driving a display panel by performing a spatial gamma mixing, a method of driving a display panel using the display panel driving apparatus, and a display apparatus having the display panel driving apparatus.

### DISCUSSION OF THE RELATED ART

A display apparatus generally includes a display panel and a display panel driving apparatus for driving the display panel.

One form of display panel is a multi-domain display panel, which is capable of providing superior visibility characteristics.

Such a display panel may be driven by performing a spatial gamma mixing. For example, data signals based on both high gamma data and low gamma data may be applied to pixels in the display panel.

Display quality of the display apparatus may be degraded by the presence of a specific pattern such as a dot pattern or a low grayscale pattern.

### SUMMARY

Exemplary embodiments of the present inventive concept provide a display panel driving apparatus capable of increasing display quality of a display apparatus.

Exemplary embodiments of the present inventive concept provide a method of driving a display panel using the above-mentioned display panel driving apparatus.

Exemplary embodiments of the present inventive concept provide a display apparatus having the above-mentioned display panel driving apparatus.

According to an exemplary embodiment of the present inventive concept, a display panel driving apparatus includes a data processing circuit, a data driving circuit and a gate driving circuit. The data processing circuit is configured to analyze image data, calculate an application rate value of a spatial gamma mixing which displays high gamma data and low gamma data on a display panel, perform the spatial gamma mixing on the image data according to the application rate value, and output image processed image data. The data driving circuit is configured to generate a data signal based on the image processed image data output from the data processing circuit, and output the data signal to a data line of the display panel. The gate driving circuit is configured to output a gate signal to a gate line of the display panel.

In an exemplary embodiment of the present inventive concept, the data processing circuit may include an application rate value calculating circuit configured to analyze the image data and calculate the application rate value according to the image data, and a spatial gamma mixing performing circuit configured to perform the spatial gamma mixing on the image data according to the application rate value and output the image processed image data.

In an exemplary embodiment of the present inventive concept, the application rate value calculating circuit may include a low grayscale area based application rate value calculating circuit configured to calculate the application rate value of the spatial gamma mixing based on a low grayscale area where low grayscale data is displayed on the display panel displaying the low gamma data of the image data, and to output a low grayscale area based application rate value, and a toggle number based application rate value calculating circuit configured to calculate the application rate value of the spatial gamma mixing based on a data toggle number between adjacent unit pixels of the display panel, and to output a toggle number based application rate value.

In an exemplary embodiment of the present inventive concept, the low grayscale area based application rate value calculating circuit may calculate the application rate value of the spatial gamma mixing based on a grayscale average value of the low grayscale area.

In an exemplary embodiment of the present inventive concept, the low grayscale average value may be obtained by dividing a sum of grayscale values of pixels where the low gamma data is displayed by a number of the pixels in which the low gamma data is displayed.

In an exemplary embodiment of the present inventive concept, when the low grayscale average value is less than a first low threshold value, the low grayscale area based application rate value may be 0. When the low grayscale average value is not less than a first high threshold value, the low grayscale area based application rate value may be about 1. When the low grayscale average value is not less than the first low threshold value and is less than the first high threshold value, the low grayscale area based application rate value may be a value between about 0 and about 1.

In an exemplary embodiment of the present inventive concept, when the low grayscale average value is not less than the first low threshold value and is less than the first high threshold value, the low grayscale area based application rate value may be increased according to an increase of the low grayscale average value.

In an exemplary embodiment of the present inventive concept, the toggle number based application rate value calculating circuit may increase the data toggle number when a grayscale value difference between the unit pixels is greater than a reference grayscale value.

In an exemplary embodiment of the present inventive concept, when the data toggle number is less than a second low threshold value, the toggle number based application rate value may be about 1. When the data toggle number is not less than a second high threshold value, the toggle number based application rate value may be about 0. When the data toggle number is not less than the second low threshold value and is less than the second high threshold value, the toggle number based application rate value may be a value between about 0 and about 1.

In an exemplary embodiment of the present inventive concept, when the data toggle number is not less than the second low threshold value and is less than the second high threshold value, the toggle number based application rate value may be decreased according to an increase of the data toggle number.

In an exemplary embodiment of the present inventive concept, the application rate value calculating circuit may include a first weighted value setting circuit configured to output a low grayscale area weighted value which is a weighted value of the low grayscale area based application rate value, and a second weighted value setting circuit configured to output a toggle number weighted value which is a weighted value of the toggle number based application rate value.

In an exemplary embodiment of the present inventive concept, the application rate value calculating circuit may include a first multiplier configured to multiply the low grayscale area based application rate value and the low grayscale area weighted value, and output a weighted value applied low grayscale area based application rate value. A second multiplier is configured to multiply the toggle number based application rate value and the toggle number weighted value, and output a weighted value applied toggle number based application rate value. An adder is configured to add the weighted value applied low grayscale area based application rate value and the weighted value applied toggle number based application rate value, and output the application rate value of the spatial gamma mixing.

In an exemplary embodiment of the present inventive concept, the application rate value calculating circuit may include a low grayscale area based application rate value calculating circuit calculating the application rate value of the spatial gamma mixing based on a low grayscale area where low grayscale data is displayed on the display panel displaying the low gamma data of the image data, to output a low grayscale area based application rate value as the application rate value.

In an exemplary embodiment of the present inventive concept, the application rate value calculating circuit may include a toggle number based application rate value calculating circuit calculating the application rate value of the spatial gamma mixing based on a data toggle number between adjacent unit pixels of the display panel, to output a toggle number based application rate value as the application rate value.

In an exemplary embodiment of the present inventive concept, the spatial gamma mixing performing circuit may include a look-up table configured to store and output a first gamma value which is a difference between a gamma value of the image data and a gamma value of a case in which the spatial gamma mixing is applied to a data process by about 100%. A multiplying circuit is configured to multiply the first gamma value and the application rate value and output a second gamma value. An adding circuit is configured to add the second gamma value to the gamma value of the image data. A subtracting circuit is configured to subtract the second gamma value from the gamma value of the image data and output to the low grayscale data.

In an exemplary embodiment of the present inventive concept, the application rate value calculating circuit may calculate the application rate value by a unit block of the display panel, and the spatial gamma mixing performing circuit may perform a spatial gamma mixing mapping on the image data based on the high gamma data and the low gamma data to output the image processed image data as a unit of one or more times of the unit block.

In an exemplary embodiment of the present inventive concept, the spatial gamma mixing performing circuit may perform the spatial gamma mixing mapping on the image data based on a spatial gamma mixing pattern indicating an arrangement of the low gamma data.

According to an exemplary embodiment of the present inventive concept, a method of driving a display panel includes calculating an application rate value of a spatial gamma mixing which displays high gamma data and low gamma data on the display panel according to image data to output an application rate value. The spatial gamma mixing is performed on the image data according to the application rate value to output image processed image data. A data signal is generated based on the image processed image data to output the data signal to a data line of the display panel. A gate signal is outputted to a gate line of the display panel.

In an exemplary embodiment of the present inventive concept, the outputting the application rate value may include calculating the application rate value of the spatial gamma mixing based on a low grayscale area where low grayscale data is displayed on the display panel displaying the low gamma data of the image data to output a low grayscale area based application rate value. The application rate value of the spatial gamma mixing is calculated based on a data toggle number between adjacent unit pixels of the display panel to output a toggle number based application rate value. A low grayscale area weighted value, which is a weighted value of the low grayscale area based application rate value, is outputted. A toggle number weighted value, which is a weighted value of the toggle number based application rate value, is outputted. The low grayscale area based application rate value and the low grayscale area weighted value are multiplied to output a weighted value applied low grayscale area based application rate value. The toggle number based application rate value and the toggle number weighted value are multiplied to output a weighted value applied toggle number based application rate value. The weighted value applied low grayscale area based application rate value and the weighted value applied toggle number based application rate value are added to output the application rate value of the spatial gamma mixing.

According to an exemplary embodiment of the present inventive concept, a display apparatus includes a display panel and a display panel driving apparatus. The display panel is configured to display an image and includes a gate line and a data line. The display panel driving apparatus includes a data processing circuit configured to analyze image data, calculate an application rate value of a spatial gamma mixing which displays high gamma data and low gamma data on a display panel, perform the spatial gamma mixing on the image data according to the application rate value, and output image processed image data. A data driving circuit is configured to generate a data signal based on the image processed image data output from the data processing circuit and output the data signal to the data line of the display panel. A gate driving circuit is configured to output a gate signal to the gate line of the display panel.

According to the present inventive concept, a data processing circuit calculates and outputs an application rate value of a spatial gamma mixing according to image data, performs a spatial gamma mixing on the image data according to the application rate value, and outputs image processed image data. Therefore, a color distortion and a resolution decrease may be prevented, and thus display quality of a display apparatus may be increased.

### BRIEF DESCRIPTION OF THE DRAWINGS

The above and other features and aspects of the present inventive concept will become more apparent by describing in detailed example embodiments thereof with reference to the accompanying drawings, in which:

FIG. 1 is a block diagram illustrating a display apparatus according to an exemplary embodiment of the present inventive concept;

FIG. 2 is a block diagram illustrating a data processing circuit of FIG. 1;

FIG. 3 is a block diagram illustrating an application rate value calculating circuit of FIG. 2;

FIG. 4 is a graph illustrating a relation between a low grayscale average value and a low grayscale area based application rate value calculated by a low grayscale area based application rate value calculating circuit of FIG. 3;

FIG. 5 is a graph illustrating a relation between a data toggle number and a toggle number based application rate value calculated by a toggle number based application rate value calculating circuit of FIG. 4;

FIG. 6 is a block diagram illustrating a spatial gamma mixing performing circuit of FIG. 2;

FIG. 7A is a graph illustrating a relation between image data and image processed image data of FIG. 1 when an application rate value of FIG. 2 is about 0;

FIG. 7B is a graph illustrating the relation between the image data and the image processed image data of FIG. 1 when the application rate value of FIG. 2 is a value between about 0 and about 1;

FIG. 7C is a graph illustrating the relation between the image data and the image processed image data of FIG. 1 when the application rate value of FIG. 2 is about 1;

FIG. 8 is a flow chart illustrating a method of driving a display panel using a display panel driving apparatus of FIG. 1;

FIG. 9 is a block diagram illustrating an application rate value calculating circuit according to an exemplary embodiment of the present invention;

FIG. 10 is a flow chart illustrating a method of a driving display panel using a display panel driving apparatus including the application rate value calculating circuit of FIG. 9;

FIG. 11 is a block diagram illustrating an application rate value calculating circuit according to an exemplary embodiment of the present invention; and

FIG. 12 is a flow chart illustrating a method of driving a display panel using a display panel driving apparatus including the application rate value calculating circuit of FIG. 11.

### DETAILED DESCRIPTION OF THE INVENTIVE CONCEPT

Hereinafter, the present inventive concept will be explained in detail with reference to the accompanying drawings.

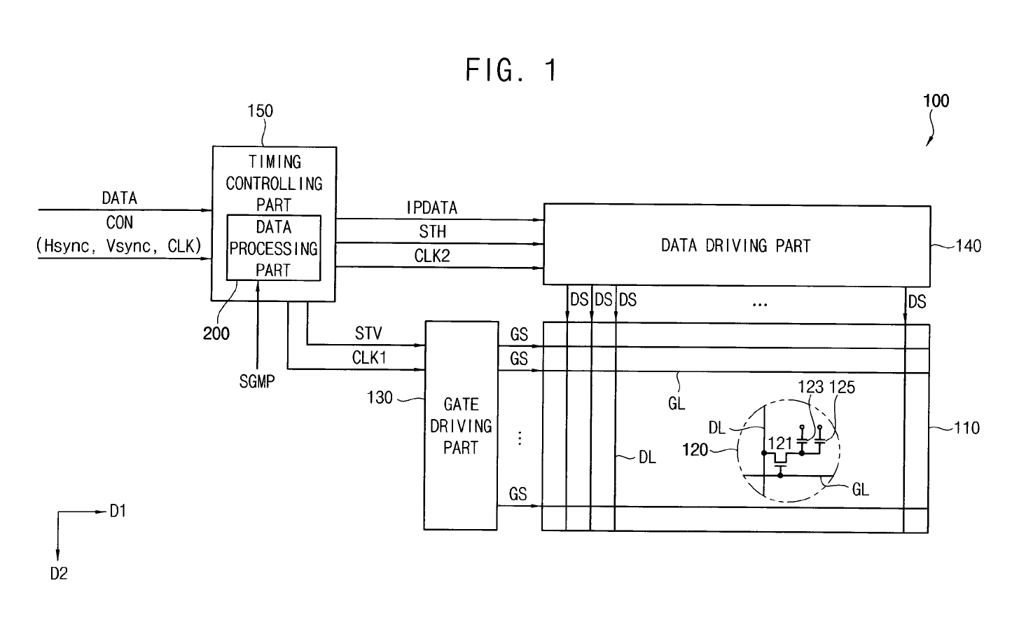

FIG. 1 is a block diagram illustrating a display apparatus according to an exemplary embodiment of the present inventive concept.

Referring to FIG. 1, the display apparatus 100 according to an exemplary embodiment includes a display panel 110, a gate driving circuit 130, a data driving circuit 140 and a timing controlling circuit 150.

The display panel 110 receives a data signal DS based on image processed image data IPDATA provided from the timing controlling circuit 150 to display an image. The display panel 110 includes gate lines GL, data lines DL and a plurality of pixels 120. The gate lines GL extend in a first direction D1 and are arranged in a second direction D2 substantially perpendicular to the first direction D1. The data lines DL extend in the second direction D2 and are arranged in the first direction D1. Each of the pixels 120 includes a thin film transistor 121 electrically connected to the gate line GL and the data line DL, a liquid crystal capacitor 123 and a storage capacitor 125 connected to the thin film transistor 121. Thus, the display panel 110 may be a liquid crystal display panel.

The gate driving circuit 130 generates a gate signal GS in response to a vertical start signal STV and a first clock signal CLK1 provided from the timing controlling circuit 150, and outputs the gate signal GS to the gate lines GL.

The data driving circuit 140 outputs the data signals DS to the data lines DL in response to a horizontal start signal STH and a second clock signal CLK2 provided from the timing controlling circuit 150.

The timing controlling circuit 150 receives the image data DATA and a control signal CON from an external source. The timing controlling circuit 150 may output image processed data IPDATA to the data driving circuit 140. The control signal CON may include a horizontal synchronous signal Hsync, a vertical synchronous signal Vsync and a clock signal CLK. The timing controlling circuit 150 generates the horizontal start signal STH using the horizontal synchronous signal Hsync and outputs the horizontal start signal STH to the data driving circuit 140. In addition, the timing controlling circuit 150 generates the vertical start signal STV using the vertical synchronous signal Vsync and outputs the vertical start signal STV to the gate driving circuit 130. In addition, the timing controlling circuit 150 generates the first clock signal CLK1 and the second clock signal CLK2 using the clock signal CLK, outputs the first clock signal CLK1 to the gate driving circuit 130, and outputs the second clock signal CLK2 to the data driving circuit 140.

The timing controlling circuit 150 may include a data processing circuit 200. The data processing circuit 200 receives the image data DATA, and performs an image process on the image data to output the image processed image data IPDATA.

The gate driving circuit 130, the data driving circuit 140 and the timing controlling circuit 150 drive the display panel 110, and thus the gate driving circuit 130, the data driving circuit 140 and the timing controlling circuit 150 may be defined as a display panel driving apparatus.

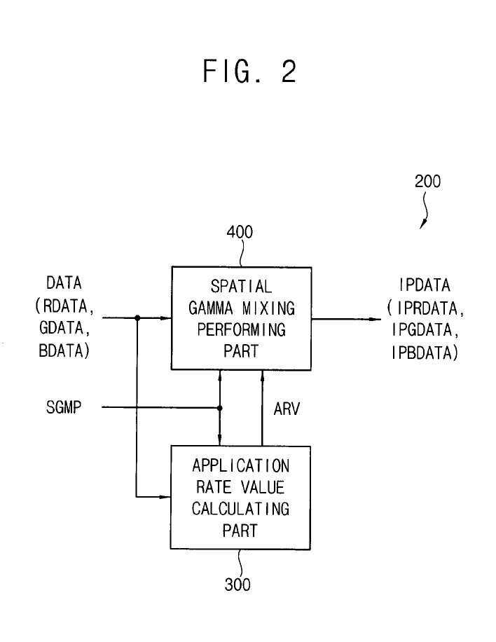

FIG. 2 is a block diagram illustrating the data processing circuit 200 of FIG. 1.

Referring to FIGS. 1 and 2, the data processing circuit includes an application rate value calculating circuit 300 and a spatial gamma mixing performing circuit 400.

The application rate value calculating circuit 300 calculates and outputs an application rate value ARV of a spatial gamma mixing which displays high gamma data and low gamma data of the image data DATA on the display panel 110. The application rate value calculating circuit 300 analyzes the image data DATA, calculates the application rate value ARV according to the image data DATA, and outputs the application rate value ARV. The application rate value calculating circuit 300 calculates the application rate value ARV based on a spatial gamma mixing pattern SGMP indicating an arrangement of the high gamma data and the low gamma data in the display panel 110.

The spatial gamma mixing performing circuit 400 performs the spatial gamma mixing on the image data DATA according to the application rate value ARV to output the image processed image data IPDATA. The image data DATA may include red data RDATA, green data GDATA and blue data BDATA. Thus, the image processed image data IPDATA may include image processed red data IPRDATA, image processed green data IPGDATA and image processed blue data IPBDATA. The spatial gamma mixing performing circuit 400 may perform the spatial gamma mixing on the image data DATA according to the spatial gamma mixing pattern SGMP to output the image processed image data IPDATA.

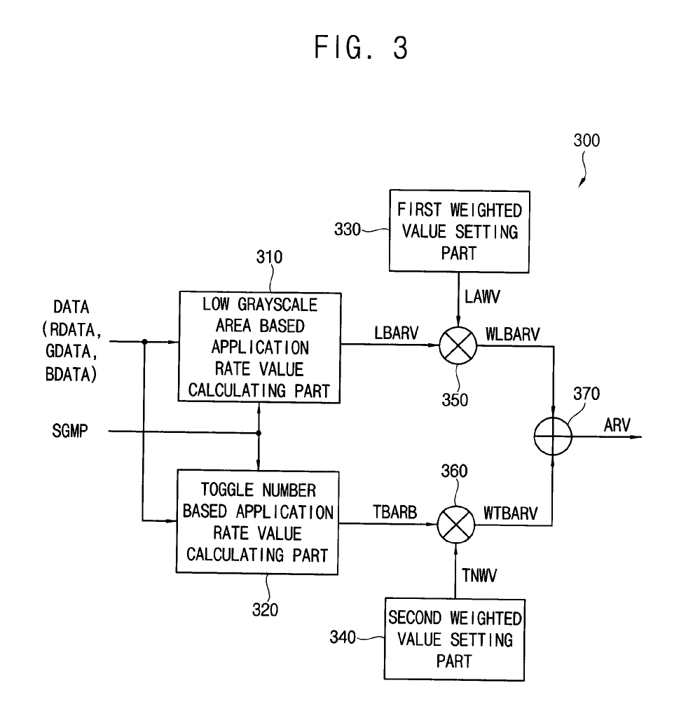

FIG. 3 is a block diagram illustrating the application rate value calculating circuit 300 of FIG. 2.

Referring to FIGS. 1 to 3, the application rate value calculating circuit 300 includes a low grayscale area based application rate value calculating circuit 310, a toggle number based application rate value calculating circuit 320, a first weighted value setting circuit 330, a second weighted value setting circuit 340, a first multiplier circuit 350, a second multiplier 360 and an adder 370.

The low grayscale area based application rate value calculating circuit 310 calculates an application rate value of the spatial gamma mixing based on a low grayscale area where low grayscale data is displayed on the display panel 110 displaying the low gamma data of the image data DATA, and outputs a low grayscale area based application rate value LBARV. For example, the low grayscale area based application rate value calculating circuit 310 calculates the application rate value of the spatial gamma mixing based on a low grayscale average value of the low grayscale area. The low grayscale average value is obtained by dividing a sum of grayscale values of pixels where the low gamma data is displayed by a number of the pixels where the low gamma data is displayed.

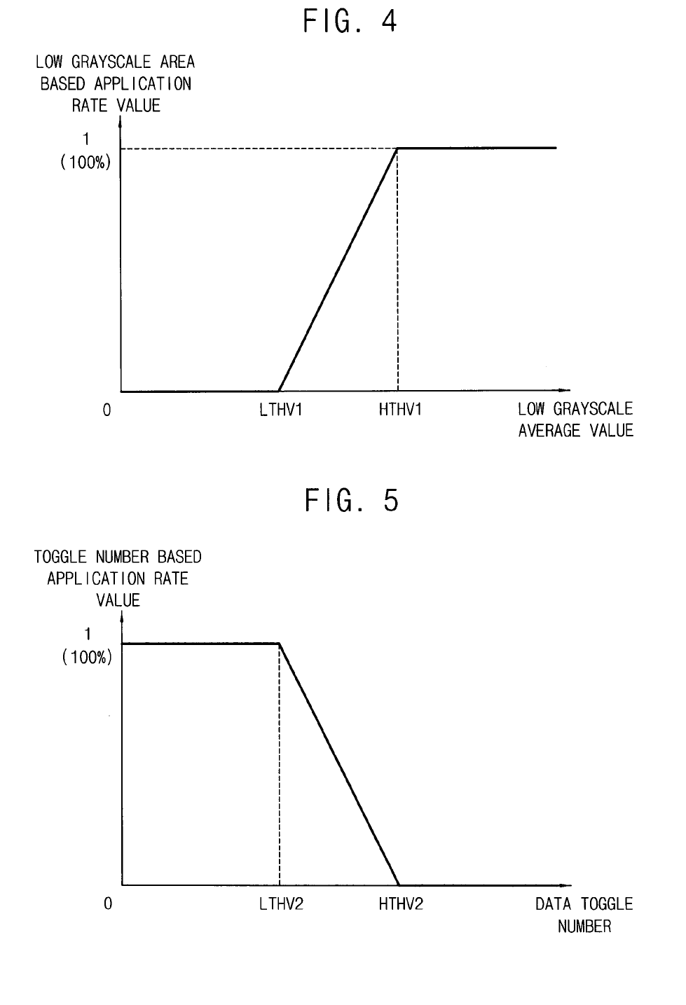

FIG. 4 is a graph illustrating a relation between the low grayscale average value and the low grayscale area based application rate value LBARV calculated by the low grayscale area based application rate value calculating circuit 310 of FIG. 3.

Referring to FIGS. 3 and 4, when the low grayscale average value is less than a first low threshold value LTH1, the low grayscale area based application rate value LBARV is about 0. When the low grayscale average value is not less than a first high threshold value HTHV1, the low grayscale area based application rate value LBARV is about 1. When the low grayscale average value is not less than the first low threshold value LTH1 and is less than the first high threshold value HTHV1, the low grayscale area based application rate value LBARV is a value between about 0 and about 1. When the low grayscale average value is not less than the first low threshold value LTH1 and is less than the first high threshold value HTHV1, the low grayscale area based application rate value LBARV is increased according to an increase of the low grayscale average value.

Referring to FIGS. 1 to 3 again, the toggle number based application rate value calculating circuit 320 calculates the application rate value of the spatial gamma maxing based on a data toggle number between adjacent unit pixels of the display panel 110, and outputs a toggle number based application rate value TBARV. The data toggle number between the adjacent unit pixels corresponds to a dot inversion number of the unit pixels. For example, the unit pixel may include a red pixel, a green pixel and a blue pixel. The toggle number based application rate value calculating circuit 320 increases the data toggle number when a grayscale value difference between unit pixels is greater than a reference grayscale value.

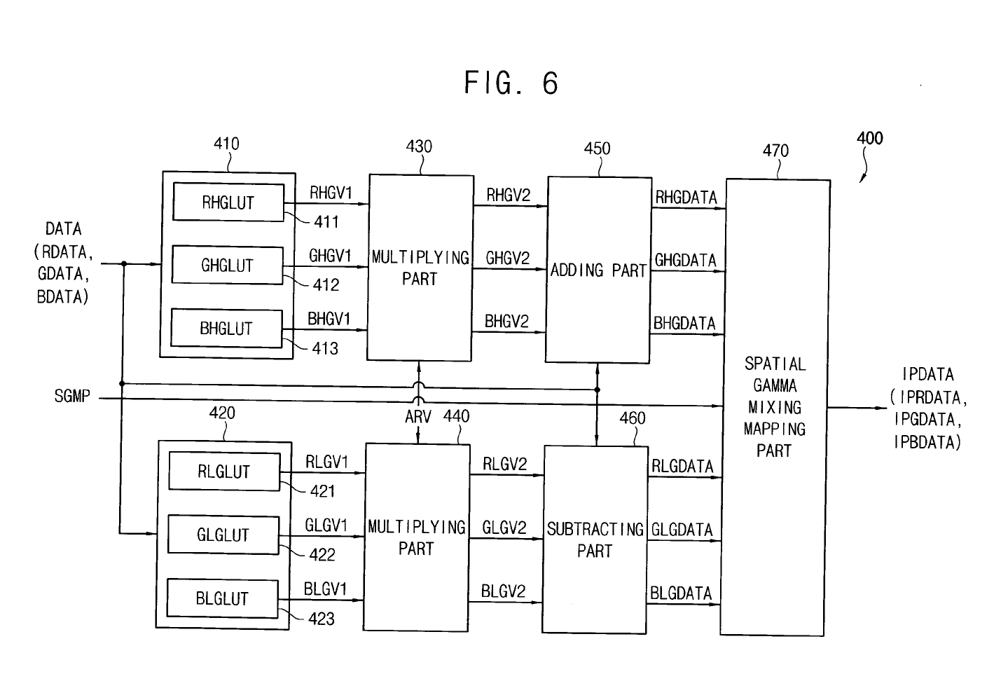

FIG. 5 is a graph illustrating a relation between the data toggle number and the toggle number based application rate value TBARV calculated by the toggle number based application rate value calculating circuit 320 of FIG. 4.

Referring to FIGS. 3 and 5, when the data toggle number is less than a second low threshold value LTHV2, the toggle number based application rate value TBARV is about 1. When the data toggle number is not less than a second high threshold value HTHV2, the toggle number based application rate value TBARV is about 0. When the data toggle number is not less than the second low threshold value LTHV2 and is less than the second high threshold value HTHV2, the toggle number based application rate value TBARV is a value between about 0 and about 1. When the data toggle number is not less than the second low threshold value LTHV2 and is less than the second high threshold value HTHV2, the toggle number based application rate value TBARV is decreased according to an increase of the data toggle number.

The first weighted value setting circuit 330 outputs a low grayscale area weighted value LAWV which is a weighted value of the low grayscale area based application rate value LBARV.

The second weighted value setting circuit 340 outputs a toggle number weighted value TNWV which is a weighted value of the toggle number based application rate value TBARV.

A sum of the low grayscale area weighted value LAWV and the toggle number weighted value TNWV is about 1. Thus, the low grayscale area weighted value LAWV is obtained by ‘1−(the toggle number weighted value TNWV)’, and the toggle number weighted value TNWV is obtained by ‘1−(low grayscale area weighted value LAWV)’.

The first multiplier 350 multiplies the low grayscale area based application rate value LBARV output from the low grayscale area based application rate value calculating circuit 310 and the low grayscale area weighted value LAWV output from the first weighted value setting circuit 330 to output a weighted value applied low grayscale area based application rate value WLBARV.

The second multiplier 360 multiplies the toggle number based application rate value TBARV output from the toggle number based application rate value calculating circuit 320 and the toggle number weighted value TNWV output from the second weighted value setting circuit 340 to output a weighted value applied toggle number based application rate value WTBARV.

The adder 370 adds the weighted value applied low grayscale area based application rate value WLBARV and the weighted value applied toggle number based application rate value WTBARV to output the application rate value ARV of the spatial gamma mixing. The application rate value ARV has about 0 to about 1, which may represent about 100%. According to an exemplary embodiment of the present inventive concept, when the application rate value ARV is less than a low threshold value, the application rate value ARV may be replaced with about 0, and when the application rate value ARV is not less than a high threshold value, the application rate value ARV may be replaced with about 1.

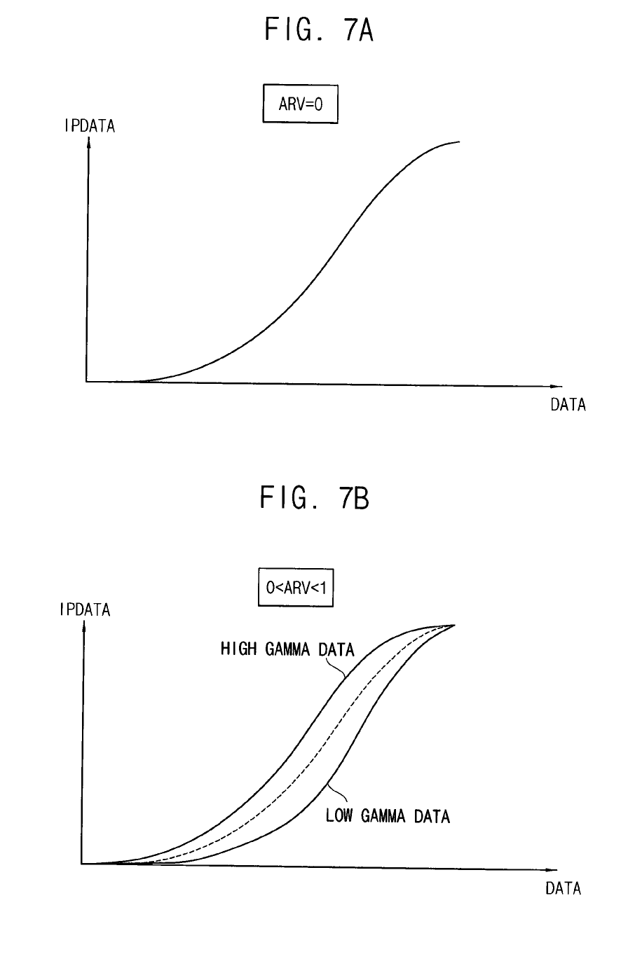

FIG. 6 is a block diagram illustrating the spatial gamma mixing performing circuit 400 of FIG. 2.

Referring to FIGS. 1, 2 and 6, the spatial gamma mixing performing circuit 400 includes a first look-up table 410, a second look-up table 420, a first multiplying circuit 430, a second multiplying circuit 440, an adding circuit 450, a subtracting circuit 460 and a spatial gamma mixing mapping circuit 470.

The first look-up table 410 and the second look-up table 420 store and output a first gamma value which is a difference between a gamma value of the image data DATA and a gamma value when the spatial gamma mixing is applied to a data process by about 100%.

For example, the first look-up table 410 includes a red high gamma look-up table 411, a green high gamma look-up table 412 and a blue high gamma look-up table 413. The red high gamma look-up table 411 stores and outputs a first red high gamma value RHGV1 which is a difference between a gamma value of the red data RDATA and a high gamma value when the spatial gamma mixing is applied to the red data RDATA by about 100%. The green high gamma look-up table 412 stores and outputs a first green high gamma value GHGV1 which is a difference between a gamma value of the green data GDATA and a high gamma value when the spatial gamma mixing is applied to the green data GDATA by about 100%. The blue high gamma look-up table 413 stores and outputs a first blue high gamma value BHGV1 which is a difference between a gamma value of the blue data BDATA and a high gamma value when the spatial gamma mixing is applied to the blue data BDATA by about 100%.

The second look-up table 420 includes a red low gamma look-up table 421, a green low gamma look-up table 422 and a blue low gamma look-up table 423. The red low gamma look-up table 421 stores and outputs a first red low gamma value RLGV1 which is a difference between the gamma value of the red data RDATA and a low gamma value when the spatial gamma mixing is applied to the red data RDATA by about 100%. The green low gamma look-up table 422 stores and outputs a first green low gamma value GLGV1 which is a difference between the gamma value of the green data GDATA and a low gamma value when the spatial gamma mixing is applied to the green data GDATA by about 100%. The blue low gamma look-up table 423 stores and outputs a first blue low gamma value BLGV1 which is a difference between a gamma value of the blue data BDATA and a low gamma value when the spatial gamma mixing is applied to the blue data BDATA by about 100%.

The first multiplying circuit 430 and the second multiplying circuit 440 multiply the first gamma value and the application rate value ARV and output a second gamma value.

For example, the first multiplying circuit 430 multiplies the first red high gamma value RHGV1 and the application rate value ARV and outputs a second red high gamma value RHGV2. In addition, the first multiplying circuit 430 multiplies the first green high gamma value GHGV1 and the application rate value ARV and outputs a second green high gamma value GHGV2. In addition, the first multiplying circuit 430 multiplies the first blue high gamma value BHGV1 and the application rate value ARV and outputs a second blue high gamma value BHGV2.

The second multiplying circuit 440 multiplies the first red low gamma value RLGV1 and the application rate value ARV and outputs a second red low gamma value RLGV2. In addition, the second multiplying circuit 440 multiplies the first green low gamma value GLGV1 and the application rate value ARV and outputs a second green low gamma value GLGV2. In addition, the second multiplying circuit 440 multiplies the first blue low gamma value BLGV1 and the application rate value ARV and outputs a second blue low gamma value BLGV2.

The adding circuit 450 adds the second gamma value to the gamma value of the image data DATA and outputs the high gamma data.

For example, the adding circuit 450 adds the second red high gamma value RHGV2 to the gamma value of the red data RDATA and outputs red high gamma data RHGDATA. In addition, the adding circuit 450 adds the second green high gamma value GHGV2 to the gamma value of the green data GDATA and outputs green high gamma data GHGDATA. In addition, the adding circuit 450 adds the second blue high gamma value BHGV2 to the gamma value of the blue data BDATA and outputs blue high gamma data BHGDATA.

The subtracting circuit 460 subtracts the second gamma value from the gamma value of the image data DATA and outputs the low gamma data.

For example, the subtracting circuit 460 subtracts the second red low gamma value RLGV2 from the gamma value of the red data RDATA and outputs red low gamma data RLGDATA. In addition, the subtracting circuit 460 subtracts the second green low gamma value GLGV2 from the gamma value of the green data GDATA and outputs green low gamma data GLGDATA. In addition, the subtracting circuit 460 subtracts the second blue low gamma value BLGV2 from the gamma value of the blue data BDATA and outputs blue low gamma data BLGDATA.

The spatial gamma mixing mapping circuit 470 performs a spatial gamma mixing mapping on the image data DATA based on the high gamma data and the low gamma data, and outputs the image processed image data IPDATA.

For example, the spatial gamma mixing mapping circuit 470 performs the spatial gamma mixing mapping on the red data RDATA based on the red high gamma data RHGDATA and the red low gamma data RLGDATA, and outputs the image processed red data IPRDATA. In addition, the spatial gamma mixing mapping circuit 470 performs the spatial gamma mixing mapping on the green data GDATA based on the green high gamma data GHGDATA and the green low gamma data GLGDATA, and outputs the image processed green data IPGDATA. In addition, the spatial gamma mixing mapping circuit 470 performs the spatial gamma mixing mapping on the blue data BDATA based on the blue high gamma data BHGDATA and the blue low gamma data BLGDATA, and outputs the image processed blue data IPBDATA.

The application rate value calculating circuit 300 may calculate the application rate value ARV by a unit block of the display panel 110. For example, the unit block may include a block of 12 by 1 pixels. The spatial gamma mixing mapping circuit 470 may output the image processed image data IPDATA according to the spatial gamma mixing pattern SGMP in a unit of N times of the unit block, where N is a positive integer.

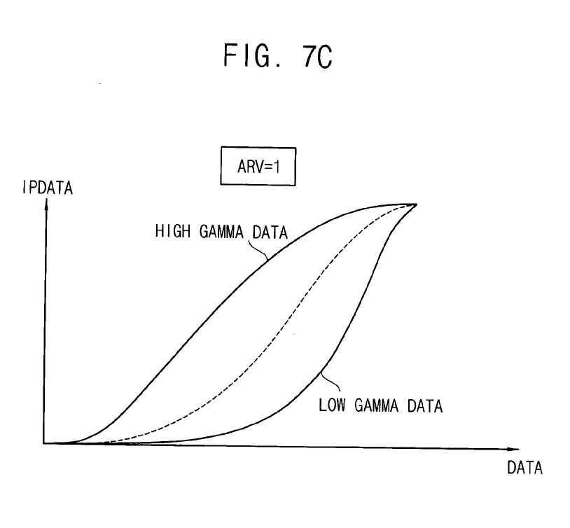

FIG. 7A is a graph illustrating a relation between the image data DATA and the image processed image data IPDATA of FIG. 1 when the application rate value ARV of FIG. 2 is about 0. FIG. 7B is a graph illustrating the relation between the image data DATA and the image processed image data IPDATA of FIG. 1 when the application rate value ARV of FIG. 2 is a value between about 0 and about 1. FIG. 7C is a graph illustrating the relation between the image data DATA and the image processed image data IPDATA of FIG. 1 when the application rate value ARV of FIG. 2 is about 1.

Referring to FIGS. 7A to 7C, a difference between the high gamma data and the low gamma data of the image processed image data IPDATA is increased according to an increase of the application rate value ARV.

In an exemplary embodiment of the present inventive concept, the data processing circuit 200 is included in the timing controlling circuit 150, but the present invention is not limited to this particular arrangement. For example, the data processing circuit 200 may be disposed between the timing controlling circuit 150 and the data driving circuit 140.

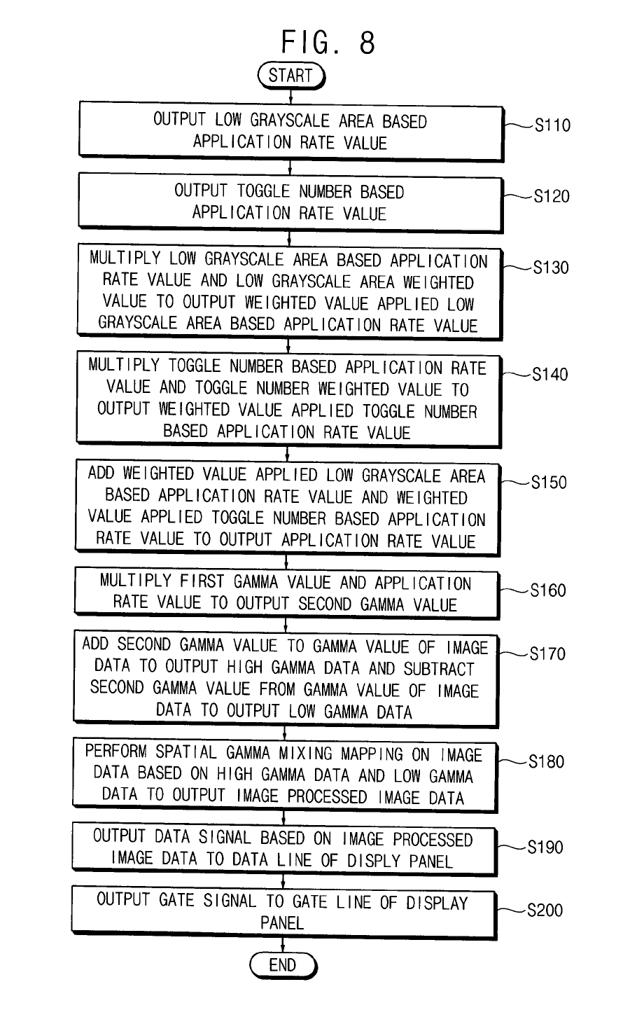

FIG. 8 is a flow chart illustrating a method of driving a display panel using the display panel driving apparatus of FIG. 1.

Referring to FIGS. 1 to 8, the low grayscale based application rate value LBARV is output (step S110). For example, the low grayscale area based application rate value calculating circuit 310 calculates the application rate value of the spatial gamma mixing based on the low grayscale area where the low grayscale data is displayed on the display panel 110 displaying the low gamma data of the image data DATA to output the low grayscale area based application rate value LBARV. The low grayscale area based application rate value calculating circuit 310 calculates the application rate value of the spatial gamma mixing based on the low grayscale average value of the low grayscale area. The low grayscale average value is obtained by dividing the sum of grayscale values of pixels where the low gamma data is displayed by the number of the pixels where the low gamma data is displayed.

When the low grayscale average value is less than the first low threshold value LTH1, the low grayscale area based application rate value LBARV is about 0. When the low grayscale average value is not less than the first high threshold value HTHV1, the low grayscale area based application rate value LBARV is about 1. When the low grayscale average value is not less than the first low threshold value LTH1 and is less than the first high threshold value HTHV1, the low grayscale area based application rate value LBARV is the value between about 0 and about 1. When the low grayscale average value is not less than the first low threshold value LTH1 and is less than the first high threshold value HTHV1, the low grayscale area based application rate value LBARV is increased according to the increase of the low grayscale average value.

The toggle number based application rate value TBARV is output (step S120). For example, the toggle number based application rate value calculating circuit 320 calculates the application rate value of the spatial gamma maxing based on the data toggle number between the adjacent unit pixels of the display panel 110 to output the toggle number based application rate value TBARV. The toggle number based application rate value calculating circuit 320 increases the data toggle number when the grayscale value difference between the unit pixels is greater than the reference grayscale value.

When the data toggle number is less than the second low threshold value LTHV2, the toggle number based application rate value TBARV is about 1. When the data toggle number is not less than the second high threshold value HTHV2, the toggle number based application rate value TBARV is about 0. When the data toggle number is not less than the second low threshold value LTHV2 and is less than the second high threshold value HTHV2, the toggle number based application rate value TBARV is the value between about 0 and about 1. When the data toggle number is not less than the second low threshold value LTHV2 and is less than the second high threshold value HTHV2, the toggle number based application rate value TBARV is decreased according to the increase of the data toggle number.

The low grayscale area based application rate value LBARV and the low grayscale area weighted value LAWV are multiplied and the weighted value applied low grayscale area based application rate value WLBARV is output (step S130). For example, the first multiplier 350 multiplies the low grayscale area based application rate value LBARV output from the low grayscale area based application rate value calculating circuit 310 and the low grayscale area weighted value LAWV output from the first weighted value setting circuit 330 to output the weighted value applied low grayscale area based application rate value WLBARV.

The toggle number based application rate value TBARV and the toggle number weighted value TNWV are multiplied and the weighted value applied toggle number based application rate value WTBARV is output (step S140). For example, the second multiplier 360 multiplies the toggle number based application rate value TBARV output from the toggle number based application rate value calculating circuit 320 and the toggle number weighted value TNWV output from the second weighted value setting circuit 340 to output the weighted value applied toggle number based application rate value WTBARV.

The weighted value applied low grayscale area based application rate value WLBARV and the weighted value applied toggle number based application rate value WTBARV are added, and the application rate value ARV of the spatial gamma mixing is output (step S150). For example, the adder 370 adds the weighted value applied low grayscale area based application rate value WLBARV and the weighted value applied toggle number based application rate value WTBARV to output the application rate value ARV of the spatial gamma mixing. The application rate value ARV has about 0 to about 1, which represents about 100%.

The first gamma value and the application rate value ARV are multiplied and the second gamma value is output (step S160).

For example, the first look-up table 410 and the second look-up table 420 store and output the first gamma value which is the difference between the gamma value of the image data DATA and the gamma value when the spatial gamma mixing is applied to the data process by about 100%. The first look-up table 410 includes the red high gamma look-up table 411, the green high gamma look-up table 412 and the blue high gamma look-up table 413. The red high gamma look-up table 411 stores and outputs the first red high gamma value RHGV1 which is the difference between the gamma value of the red data RDATA and the high gamma value when the spatial gamma mixing is applied to the red data RDATA by about 100%. The green high gamma look-up table 412 stores and outputs the first green high gamma value GHGV1 which is the difference between the gamma value of the green data GDATA and the high gamma value when the spatial gamma mixing is applied to the green data GDATA by about 100%. The blue high gamma look-up table 413 stores and outputs the first blue high gamma value BHGV1 which is the difference between the gamma value of the blue data BDATA and the high gamma value when the spatial gamma mixing is applied to the blue data BDATA by about 100%. The second look-up table 420 includes the red low gamma look-up table 421, the green low gamma look-up table 422 and the blue low gamma look-up table 423. The red low gamma look-up table 421 stores and outputs a first red low gamma value RLGV1 which is a difference between the gamma value of the red data RDATA and a low gamma value when the spatial gamma mixing is applied to the red data RDATA by about 100%. The green low gamma look-up table 422 stores and outputs the first green low gamma value GLGV1 which is the difference between the gamma value of the green data GDATA and the low gamma value when the spatial gamma mixing is applied to the green data GDATA by about 100%. The blue low gamma look-up table 423 stores and outputs the first blue low gamma value BLGV1 which is the difference between the gamma value of the blue data BDATA and the low gamma value when the spatial gamma mixing is applied to the blue data BDATA by about 100%.

The first multiplying circuit 430 and the second multiplying circuit 440 multiply the first gamma value and the application rate value ARV to output the second gamma value. The first multiplying circuit 430 multiplies the first red high gamma value RHGV1 and the application rate value ARV to output the second red high gamma value RHGV2. In addition, the first multiplying circuit 430 multiplies the first green high gamma value GHGV1 and the application rate value ARV to output the second green high gamma value GHGV2. In addition, the first multiplying circuit 430 multiplies the first blue high gamma value BHGV1 and the application rate value ARV to output the second blue high gamma value BHGV2. The second multiplying circuit 440 multiplies the first red low gamma value RLGV1 and the application rate value ARV to output the second red low gamma value RLGV2. In addition, the second multiplying circuit 440 multiplies the first green low gamma value GLGV1 and the application rate value ARV to output the second green low gamma value GLGV2. In addition, the second multiplying circuit 440 multiplies the first blue low gamma value BLGV1 and the application rate value ARV to output the second blue low gamma value BLGV2.

The second gamma value is added to the gamma value of the image data DATA to output the high gamma data. The second gamma value is subtracted from the gamma value of the image data DATA to output the low gamma data (step S170).

For example, the adding circuit 450 adds the second gamma value to the gamma value of the image data DATA to output the high gamma data. The adding circuit 450 adds the second red high gamma value RHGV2 to the gamma value of the red data RDATA to output the red high gamma data RHGDATA. In addition, the adding circuit 450 adds the second green high gamma value GHGV2 to the gamma value of the green data GDATA to output the green high gamma data GHGDATA. In addition, the adding circuit 450 adds the second blue high gamma value BHGV2 to the gamma value of the blue data BDATA to output the blue high gamma data BHGDATA.

The subtracting circuit 460 subtracts the second gamma value from the gamma value of the image data DATA to output the low gamma data. The subtracting circuit 460 subtracts the second red low gamma value RLGV2 from the gamma value of the red data RDATA to output the red low gamma data RLGDATA. In addition, the subtracting circuit 460 subtracts the second green low gamma value GLGV2 from the gamma value of the green data GDATA to output the green low gamma data GLGDATA. In addition, the subtracting circuit 460 subtracts the second blue low gamma value BLGV2 from the gamma value of the blue data BDATA to output the blue low gamma data BLGDATA.

The spatial gamma mixing mapping is performed on the image data DATA based on the high gamma data and the low gamma data to output the image processed image data IPDATA (step S180).

For example, the spatial gamma mixing mapping circuit 470 performs the spatial gamma mixing mapping on the image data DATA based on the high gamma data and the low gamma data to output the image processed image data IPDATA. The spatial gamma mixing mapping circuit 470 performs the spatial gamma mixing mapping on the red data RDATA based on the red high gamma data RHGDATA and the red low gamma data RLGDATA to output the image processed red data IPRDATA. In addition, the spatial gamma mixing mapping circuit 470 performs the spatial gamma mixing mapping on the green data GDATA based on the green high gamma data GHGDATA and the green low gamma data GLGDATA to output the image processed green data IPGDATA. In addition, the spatial gamma mixing mapping circuit 470 performs the spatial gamma mixing mapping on the blue data BDATA based on the blue high gamma data BHGDATA and the blue low gamma data BLGDATA to output the image processed blue data IPBDATA. The spatial gamma mixing mapping circuit 470 may output the image processed image data IPDATA according to the spatial gamma mixing pattern SGMP.

The data signal DS based on the image processed image data IPDATA is output to the data line DL of the display panel 110 (step S190). For example, the data driving circuit 140 outputs the data signals DS to the data line DL in response to the horizontal start signal STH and the second clock signal CLK2 provided from the timing controlling circuit 150.

The gate signal is output to the gate line GL of the display panel 110 (step S200). For example, the gate driving circuit 130 generates the gate signal GS in response to the vertical start signal STV and the first clock signal CLK1 provided from the timing controlling circuit 150, and outputs the gate signal GS to the gate line GL.

In a case where the unit pixel of the display panel 110 sequentially includes the red pixel, the green pixel and the blue pixel in the first direction D1, the unit pixel is repeatedly disposed in the first direction D1 and the second direction D2, and the display panel 110 is driven in a dot inversion method by the unit pixel, when the spatial gamma mixing is applied to the image data DATA by about 100%, only the high gamma data is displayed and the low gamma data is not displayed in the red pixel and the blue pixel, and only the low gamma data is displayed and the high gamma data is not displayed in the red pixel. Thus, a color distortion may be generated.

In addition, when the low gamma data is displayed in the low grayscale area where the low grayscale data is displayed in the display panel 110, a resolution decrease may be generated in the low grayscale area.

To prevent the color distortion and the resolution decrease, the data processing circuit 200 may decrease the application rate value ARV, and may either perform or not perform the spatial gamma mixing on the image data DATA according to the decreased application rate value.

According to an exemplary embodiment of the present inventive concept, the data processing circuit 200 calculates and outputs the application rate value ARV of the spatial gamma mixing according to the image data DATA, performs the spatial gamma mixing on the image data DATA according to the application rate value ARV, and outputs the image processed image data IPDATA. Therefore, the color distortion and the resolution decrease may be prevented, and thus display quality of the display apparatus 100 may be increased.

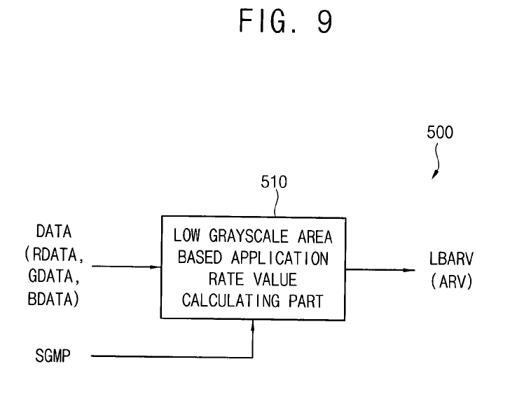

FIG. 9 is a block diagram illustrating an application rate value calculating circuit 500 according to an exemplary embodiment of the present invention. The application rate value calculating circuit 500 according to an exemplary embodiment illustrated in FIG. 9 may be in the data processing circuit 200 of the display apparatus 100 according to the approach illustrated in FIG. 1 and described above, and the data processing circuit 200 including the application rate value calculating circuit 500 is substantially the same as the data processing circuit 200 according to the approach illustrated in FIGS. 1 and 2 and described above except for the application rate value calculating circuit 500. Thus, the same reference numerals may be used to refer to same or like circuits as those described previously and any further repetitive explanation concerning the above elements will be omitted.

Referring to FIG. 9, the application rate value calculating circuit 500 includes a low grayscale area based application rate value calculating circuit 510. The application rate value calculating circuit 500 calculates and outputs the application rate value ARV of the spatial gamma mixing which displays the high gamma data and the low gamma data of the image data DATA on the display panel 110. The application rate value calculating circuit 500 analyzes the image data DATA, calculates the application rate value ARV according to the image data DATA, and outputs the application rate value ARV. The application rate value calculating circuit 500 calculates the application rate value ARV based on the spatial gamma mixing pattern SGMP indicating the arrangement of the high gamma data and the low gamma data in the display panel 110.

The low grayscale area based application rate value calculating circuit 510 of the application rate value calculating circuit 500 calculates an application rate value of the spatial gamma mixing based on a low grayscale area where low grayscale data is displayed on the display panel 110 displaying the low gamma data of the image data DATA, and outputs a low grayscale area based application rate value LBARV as the application rate value ARV. For example, the low grayscale area based application rate value calculating circuit 510 calculates the application rate value of the spatial gamma mixing based on a low grayscale average value of the low grayscale area. The low grayscale average value is obtained by dividing a sum of grayscale values of pixels where the low gamma data is displayed by a number of the pixels where the low gamma data is displayed.

A graph illustrating a relation between the low grayscale average value and the low grayscale area based application rate value LBARV calculated by the low grayscale area based application rate value calculating circuit 510 is substantially the same as the graph illustrating the relation between the low grayscale average value and the low grayscale area based application rate value LBARV illustrated in FIG. 4.

Thus, when the low grayscale average value is less than the first low threshold value LTH1, the low grayscale area based application rate value LBARV is about 0. When the low grayscale average value is not less than the first high threshold value HTHV1, the low grayscale area based application rate value LBARV is about 1. When the low grayscale average value is not less than the first low threshold value LTH1 and is less than the first high threshold value HTHV1, the low grayscale area based application rate value LBARV is a value between about 0 and about 1. When the low grayscale average value is not less than the first low threshold value LTH1 and is less than the first high threshold value HTHV1, the low grayscale area based application rate value LBARV is increased according to an increase of the low grayscale average value.

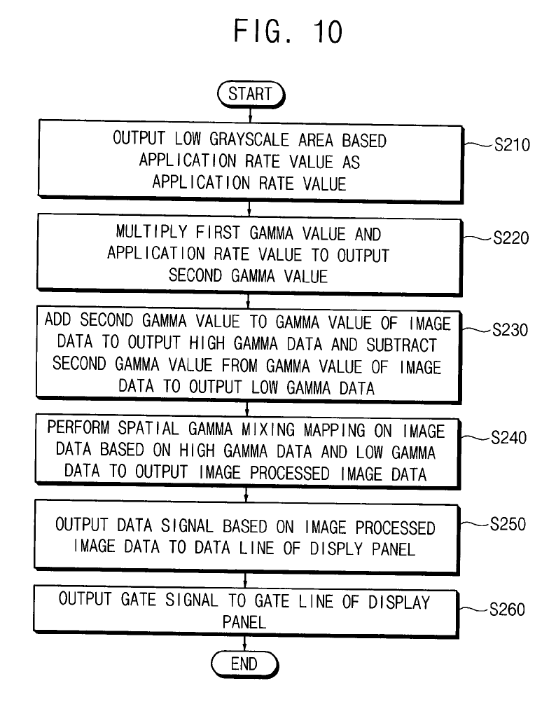

FIG. 10 is a flow chart illustrating a method of a driving display panel using a display panel driving apparatus including the application rate value calculating circuit 500 of FIG. 9.

Referring to FIGS. 9 and 10, the low grayscale based application rate value LBARV is output as the application rate value ARV (step S210). For example, the low grayscale area based application rate value calculating circuit 510 of the application rate value calculating circuit 500 calculates the application rate value of the spatial gamma mixing based on the low grayscale area where the low grayscale data is displayed on the display panel 110 displaying the low gamma data of the image data DATA, and outputs the low grayscale area based application rate value LBARV as the application rate value ARV. The low grayscale area based application rate value calculating circuit 510 calculates the application rate value of the spatial gamma mixing based on the low grayscale average value of the low grayscale area. The low grayscale average value is obtained by dividing the sum of grayscale values of the pixels where the low gamma data is displayed by the number of the pixels where the low gamma data is displayed.

The graph illustrating the relation between the low grayscale average value and the low grayscale area based application rate value LBARV is substantially the same as the graph illustrating the relation between the low grayscale average value and the low grayscale area based application rate value LBARV illustrated in FIG. 4. Thus, when the low grayscale average value is less than the first low threshold value LTH1, the low grayscale area based application rate value LBARV is about 0. When the low grayscale average value is not less than the first high threshold value HTHV1, the low grayscale area based application rate value LBARV is about 1. When the low grayscale average value is not less than the first low threshold value LTH1 and is less than the first high threshold value HTHV1, the low grayscale area based application rate value LBARV is the value between about 0 and about 1. When the low grayscale average value is not less than the first low threshold value LTH1 and is less than the first high threshold value HTHV1, the low grayscale area based application rate value LBARV is increased according to the increase of the low grayscale average value.

Steps S220, S230, S240, S250 and S260 are substantially the same as the S160, S170, S180, S190 and S200 according to the previous exemplary embodiment illustrated in FIG. 8, respectively.

When the low gamma data is displayed in the low grayscale area where the low grayscale data is displayed in the display panel 110, a resolution decrease may be generated in the low grayscale area.

To prevent the resolution decrease, the data processing circuit 200 including the application rate value calculating circuit 500 may decrease the application rate value ARV, and may perform or may not perform the spatial gamma mixing on the image data DATA according to the decreased application rate value.

According to an exemplary embodiment of the present inventive concept, the data processing circuit 200 including the application rate value calculating circuit 500 calculates and outputs the application rate value ARV of the spatial gamma mixing according to the image data DATA, performs the spatial gamma mixing on the image data DATA according to the application rate value ARV, and outputs the image processed image data IPDATA. Therefore, the resolution decrease may be prevented, and thus display quality of the display apparatus 100 may be increased.

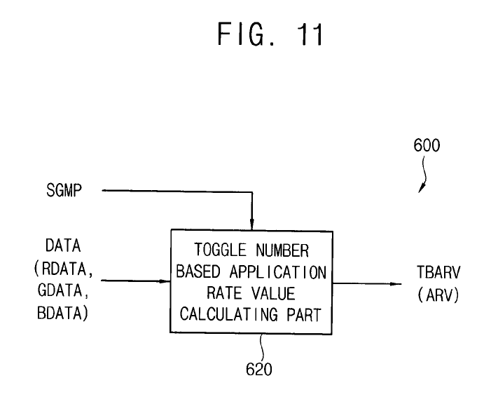

FIG. 11 is a block diagram illustrating an application rate value calculating circuit 600 according to an exemplary embodiment of the present invention. The application rate value calculating circuit 600 as illustrated in FIG. 11 may be in the data processing circuit 200 of the display apparatus 100 according to the approach illustrated in FIG. 1, and the data processing circuit 200 including the application rate value calculating circuit 600 may be substantially the same as the data processing circuit 200 illustrated in FIGS. 1 and 2 except for the application rate value calculating circuit 600. Thus, the same reference numerals may be used to refer to same or like circuits as those described previously and any further repetitive explanation concerning the above elements will be omitted.

Referring to FIG. 11, the application rate value calculating circuit 600 includes a toggle number based application rate value calculating circuit 620. The application rate value calculating circuit 600 calculates and outputs the application rate value ARV of the spatial gamma mixing which displays the high gamma data and the low gamma data of the image data DATA on the display panel 110. The application rate value calculating circuit 600 analyzes the image data DATA, calculates the application rate value ARV according to the image data DATA, and outputs the application rate value ARV. The application rate value calculating circuit 600 calculates the application rate value ARV based on the spatial gamma mixing pattern SGMP indicating the arrangement of the high gamma data and the low gamma data in the display panel 110.

The toggle number based application rate value calculating circuit 620 of the application rate value calculating circuit 600 calculates the application rate value of the spatial gamma maxing based on a data toggle number between adjacent unit pixels of the display panel 110, and outputs a toggle number based application rate value TBARV as the application rate value ARV. The data toggle number between the adjacent unit pixels corresponds to a dot inversion number of the unit pixels. For example, the unit pixel may include a red pixel, a green pixel and a blue pixel. The toggle number based application rate value calculating circuit 620 increases the data toggle number when a grayscale value difference between unit pixels is greater than a reference grayscale value.

A graph illustrating a relation between the data toggle number and the toggle number based application rate value TBARV calculated by the toggle number based application rate value calculating circuit 620 is substantially the same as the graph illustrating the relation between the data toggle number and the toggle number based application rate value TBARV illustrated in FIG. 5.

Thus, when the data toggle number is less than the second low threshold value LTHV2, the toggle number based application rate value TBARV is about 1. When the data toggle number is not less than the second high threshold value HTHV2, the toggle number based application rate value TBARV is about 0. When the data toggle number is not less than the second low threshold value LTHV2 and is less than the second high threshold value HTHV2, the toggle number based application rate value TBARV is a value between about 0 and about 1. When the data toggle number is not less than the second low threshold value LTHV2 and is less than the second high threshold value HTHV2, the toggle number based application rate value TBARV is decreased according to an increase of the data toggle number.

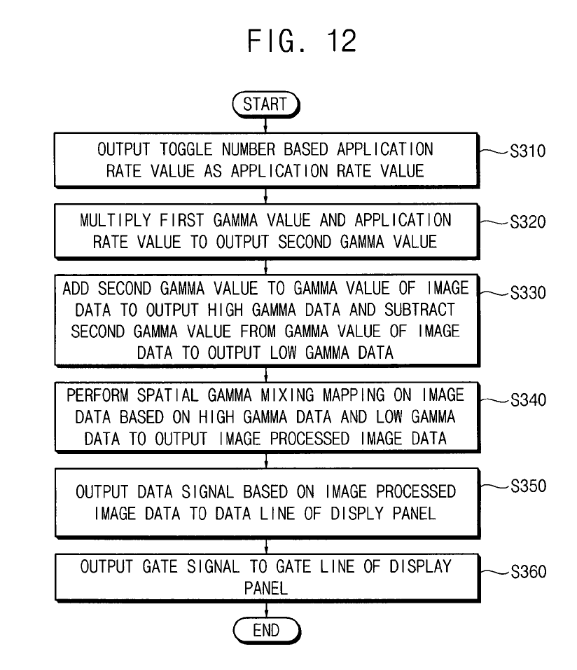

FIG. 12 is a flow chart illustrating a method of driving a display panel using the display panel driving apparatus including the application rate value calculating circuit 600 of FIG. 11.

Referring to FIGS. 11 and 12, the toggle number based application rate value TBARV is output as the application rate value ARV (step S310). For example, the toggle number based application rate value calculating circuit 620 of the application rate value calculating circuit 600 calculates the application rate value of the spatial gamma maxing based on the data toggle number between the adjacent unit pixels of the display panel 110, and outputs the toggle number based application rate value TBARV as the application rate value ARV. The data toggle number between the adjacent unit pixels corresponds to the dot inversion number of the unit pixels.

The graph illustrating the relation between the data toggle number and the toggle number based application rate value TBARV calculated by the toggle number based application rate value calculating circuit 620 is substantially the same as the graph illustrating the relation between the data toggle number and the toggle number based application rate value TBARV illustrated in FIG. 4. Thus, when the data toggle number is less than the second low threshold value LTHV2, the toggle number based application rate value TBARV is about 1. When the data toggle number is not less than the second high threshold value HTHV2, the toggle number based application rate value TBARV is about 0. When the data toggle number is not less than the second low threshold value LTHV2 and is less than the second high threshold value HTHV2, the toggle number based application rate value TBARV is the value between about 0 and about 1. When the data toggle number is not less than the second low threshold value LTHV2 and is less than the second high threshold value HTHV2, the toggle number based application rate value TBARV is decreased according to the increase of the data toggle number.

Steps S320, S330, S340, S350 and S360 are substantially the same as the steps S160, S170, S180, S190 and S200 illustrated in FIG. 8 and described above, respectively.

In a case where the unit pixel of the display panel 110 sequentially includes the red pixel, the green pixel and the blue pixel in the first direction D1, the unit pixel is repeatedly disposed in the first direction D1 and the second direction D2, and the display panel 110 is driven in a dot inversion method by the unit pixel, when the spatial gamma mixing is applied to the image data DATA by about 100%, only the high gamma data is displayed and the low gamma data is not displayed in the red pixel and the blue pixel, and only the low gamma data is displayed and the high gamma data is not displayed in the red pixel. Thus, a color distortion may be generated.

To prevent the color distortion, the data processing circuit 200 including the application rate value calculating circuit 600 may decrease the application rate value ARV, and may perform or may not perform the spatial gamma mixing on the image data DATA according to the decreased application rate value.

According to an exemplary embodiment of the present inventive concept, the data processing circuit 200 calculates and outputs the application rate value ARV of the spatial gamma mixing according to the image data DATA, performs the spatial gamma mixing on the image data DATA according to the application rate value ARV, and outputs the image processed image data IPDATA. Therefore, the color distortion may be prevented, and thus display quality of the display apparatus 100 may be increased.

A data processing circuit, which may be included in a driving apparatus of a display panel, calculates and outputs an application rate value of a spatial gamma mixing according to image data, performs a spatial gamma mixing on the image data according to the application rate value, and outputs image processed image data. Therefore, a color distortion and a resolution decrease may be prevented, and thus display quality of a display apparatus may be increased.

Exemplary embodiments of the present inventive concept have been described above and as those skilled in the art will readily appreciate, many modifications are possible without materially departing from the novel teachings and aspects of the present inventive concept. Accordingly, all such modifications are intended to be included within the scope of the present inventive concept.

What is claimed is:

1. A display panel driving apparatus comprising:
a data processor configured to analyze image data, calculate an application rate value of a spatial gamma mixing which displays high gamma data and low gamma data on a display panel, perform the spatial gamma mixing on the image data according to the calculated application rate value, and output image processed image data;
a data driving circuit configured to generate a data signal based on the image processed image data output from the data processor, and output the generated data signal to a data line of the display panel; and
a gate driving circuit configured to output a gate signal to a gate line of the display panel.

2. The display panel driving apparatus of claim 1, wherein the data processor comprises:
an application rate value calculating circuit configured to analyze the image data and calculate the application rate value according to the image data; and
a spatial gamma mixing performing circuit configured to perform the spatial gamma mixing on the image data according to the application rate value and output the image processed image data.

3. The display panel driving apparatus of claim 2, wherein the application rate value calculating circuit comprises:
a low grayscale area based application rate value calculating circuit configured to calculate the application rate value of the spatial gamma mixing based on a low grayscale area where low grayscale data is displayed on the display panel displaying the low gamma data of the image data, and to output a low grayscale area based application rate value; and
a toggle number based application rate value calculating circuit configured to calculate the application rate value of the spatial gamma mixing based on a data toggle number between adjacent unit pixels of the display panel, and to output a toggle number based application rate value.

4. The display panel driving apparatus of claim 3, wherein the low grayscale area based application rate value calculating circuit calculates the application rate value of the spatial gamma mixing based on a grayscale average value of the low grayscale area.

5. The display panel driving apparatus of claim 4, wherein the low grayscale average value is obtained by dividing a sum of grayscale values of pixels where the low gamma data is displayed by a number of the pixels where the low gamma data is displayed.

6. The display panel driving apparatus of claim 3, wherein, when the low grayscale average value is less than a first low threshold value, the low grayscale area based application rate value is about 0, when the low grayscale average value is not less than a first high threshold value, the low grayscale area based application rate value is about 1, and when the low grayscale average value is not less than the first low threshold value and is less than the first high threshold value, the low grayscale area based application rate value is a value between about 0 and about 1.

7. The display panel driving apparatus of claim 6, wherein, when the low grayscale average value is not less than the first low threshold value and is less than the first high threshold value, the low grayscale area based application rate value is increased according to an increase of the low grayscale average value.

8. The display panel driving apparatus of claim 3, wherein the toggle number based application rate value calculating circuit increases the data toggle number when a grayscale value difference between the unit pixels is greater than a reference grayscale value.

9. The display panel driving apparatus of claim 8, wherein, when the data toggle number is less than a second low threshold value, the toggle number based application rate value is about 1, when the data toggle number is not less than a second high threshold value, the toggle number based application rate value is about 0, and when the data toggle number is not less than the second low threshold value and is less than the second high threshold value, the toggle number based application rate value is a value between about 0 and about 1.

10. The display panel driving apparatus of claim 9, wherein, when the data toggle number is not less than the second low threshold value and is less than the second high threshold value, the toggle number based application rate value is decreased according to an increase of the data toggle number.

11. The display panel driving apparatus of claim 3, wherein the application rate value calculating circuit comprises:
a first weighted value setting circuit configured to output a low grayscale area weighted value which is a weighted value of the low grayscale area based application rate value; and
a second weighted value setting circuit configured to output a toggle number weighted value which is a weighted value of the toggle number based application rate value.

12. The display panel driving apparatus of claim 11, wherein the application rate value calculating circuit comprises:
a first multiplier configured to multiply the low grayscale area based application rate value and the low grayscale area weighted value, and output a weighted value applied low grayscale area based application rate value;
a second multiplier configured to multiply the toggle number based application rate value and the toggle number weighted value, and output a weighted value applied toggle number based application rate value; and
an adder configured to add the weighted value applied low grayscale area based application rate value and the weighted value applied toggle number based application rate value, and output the application rate value of the spatial gamma mixing.

13. The display panel driving apparatus of claim 2, wherein the application rate value calculating circuit comprises a low grayscale area based application rate value calculating circuit calculating the application rate value of the spatial gamma mixing based on a low grayscale area where low grayscale data is displayed on the display panel displaying the low gamma data of the image data, to output a low grayscale area based application rate value as the application rate value.

14. The display panel driving apparatus of claim 2, wherein the application rate value calculating circuit comprises a toggle number based application rate value calculating circuit calculating the application rate value of the spatial gamma mixing based on a data toggle number between adjacent unit pixels of the display panel, to output a toggle number based application rate value as the application rate value.

15. The display panel driving apparatus of claim 2, wherein the spatial gamma mixing performing circuit comprises:
a look-up table configured to store and output a first gamma value which is equal to a difference between a gamma value of the image data and a gamma value of a case in which the spatial gamma mixing is applied to a data process by about 100%;
a multiplying circuit configured to multiply the first gamma value and the application rate value and output a second gamma value;
an adding circuit configured to add the second gamma value to the gamma value of the image data; and
a subtracting circuit configured to subtract the second gamma value from the gamma value of the image data and output to the low grayscale data.

16. The display panel driving apparatus of claim 15, wherein the application rate value calculating circuit calculates the application rate value by a unit block of the display panel, and
wherein the spatial gamma mixing performing circuit performs a spatial gamma mixing mapping on the image data based on the high gamma data and the low gamma data to output the image processed image data as a unit of one or more times of the unit block.

17. The display panel driving apparatus of claim 16, wherein the spatial gamma mixing performing circuit performs the spatial gamma mixing mapping on the image data based on a spatial gamma mixing pattern indicating an arrangement of the low gamma data.

18. A method of driving a display panel, the method comprising:
calculating an application rate value of a spatial gamma mixing which displays high gamma data and low gamma data on the display panel according to image data and outputting the calculated application rate value;
performing the spatial gamma mixing on the image data according to the calculated application rate value and outputting the spatial gamma mixed image data as image processed image data;
generating a data signal based on the image processed image data and outputting the generated data signal to a data line of the display panel; and
outputting a gate signal to a gate line of the display panel.

19. The method of claim 18, wherein the outputting of the application rate value comprises:
calculating the application rate value of the spatial gamma mixing based on a low grayscale area where low grayscale data is displayed on the display panel displaying the low gamma data of the image data to output a low grayscale area based application rate value;
calculating the application rate value of the spatial gamma mixing based on a data toggle number between adjacent unit pixels of the display panel to output a toggle number based application rate value;
outputting a low grayscale area weighted value which is a weighted value of the low grayscale area based application rate value;
outputting a toggle number weighted value which is a weighted value of the toggle number based application rate value;
multiplying the low grayscale area based application rate value and the low grayscale area weighted value to output a weighted value applied low grayscale area based application rate value;
multiplying the toggle number based application rate value and the toggle number weighted value to output a weighted value applied toggle number based application rate value; and
adding the weighted value applied low grayscale area based application rate value and the weighted value applied toggle number based application rate value to output the application rate value of the spatial gamma mixing.

20. A display apparatus comprising:
a display panel configured to display an image, and the display panel comprising a gate line and a data line; and
a display panel driving apparatus comprising a data processor configured to analyze image data, calculate an application rate value of a spatial gamma mixing which displays high gamma data and low gamma data on a display panel, perform the spatial gamma mixing on the image data according to the calculated application rate value, and output image processed image data, a data driving circuit configured to generate a data signal based on the image processed image data output from the data processor and output the data signal to the data line of the display panel, and a gate driving circuit configured to output a gate signal to the gate line of the display panel.
